(19) United States
(12) Patent Application Publication
(10) Pub. No.: US 2020/0137422 A1
(43) Pub. Date: Apr. 30, 2020

(54) SYSTEMS AND METHODS FOR GEOMETRY-ADAPTIVE BLOCK PARTITIONING OF A PICTURE INTO VIDEO BLOCKS FOR VIDEO CODING

(71) Applicant: Sharp Kabushiki Kaisha, Sakai City, Osaka (JP)

(72) Inventors: Kiran Mukesh MISRA, Vancouver, WA (US); Jie ZHAO, Vancouver, WA (US); Christopher Andrew SEGALL, Vancouver, WA (US); Michael HOROWITZ, Vancouver, WA (US)

(21) Appl. No.: 16/626,593

(22) PCT Filed: Jun. 28, 2018
(86) PCT No.: PCT/JP2018/024627

§ 371 Date: Dec. 26, 2019

Related U.S. Application Data
(60) Provisional application No. 62/527,527, filed on Jun. 30, 2017.

(51) Int. Cl. H04N 19/64; H04N 19/96; H04N 19/132; H04N 19/70; H04N 19/105; H04N 19/176

(52) U.S. Cl. CPC H04N 19/647; H04N 19/96; H04N 19/176; H04N 19/70; H04N 19/105; H04N 19/132

(57) ABSTRACT

A method of partitioning video data for video coding is disclosed. The method comprises receiving a video block which includes sample values for a component of video data, partitioning the video block according to a partitioning line which is defined according to an angle and an distance, and signaling the partitioning line based on allowed values for the angle and the distance. The allowed values are based on one or more of properties of video data or video coding parameters.

### CROSS REFERENCE

This Nonprovisional application claims priority under 35 U.S.C. § 119 on provisional Application No. 62/527,527 on Jun. 30, 2017, the entire contents of which are hereby incorporated by reference.

### TECHNICAL FIELD

This disclosure relates to video coding and more particularly to techniques for partitioning a picture of video data.

### BACKGROUND ART

Digital video capabilities can be incorporated into a wide range of devices, including digital televisions, laptop or desktop computers, tablet computers, digital recording devices, digital media players, video gaming devices, cellular telephones, including socalled smartphones, medical imaging devices, and the like. Digital video may be coded according to a video coding standard. Video coding standards may incorporate video compression techniques. Examples of video coding standards include ISO/IEC MPEG4 Visual and ITU-T H.264 (also known as ISO/IEC MPEG-4 AVC) and High-Efficiency Video Coding (HEVC). HEVC is described in High Efficiency Video Coding (HEVC), Rec. ITU-T H.265 April 2015, which is incorporated by reference, and referred to herein as ITU-T H.265. Extensions and improvements for ITU-T H.265 are currently being considered for development of next generation video coding standards. For example, the ITU-T Video Coding Experts Group (VCEG) and ISO/IEC (Moving Picture Experts Group (MPEG) (collectively referred to as the Joint Video Exploration Team (JVET)) are studying the potential need for standardization of future video coding technology with a compression capability that significantly exceeds that of the current HEVC standard. The Joint Exploration Model 3 (JEM 3), Algorithm Description of Joint Exploration Test Model 3 (JEM 3), ISO/IEC JTC1/SC29/WG11 Document: JVET-C1001v3, May 2016, Geneva, CH, which is incorporated by reference herein, describes the coding features that are under coordinated test model study by the JVET as potentially enhancing video coding technology beyond the capabilities of ITU-T H.265. It should be noted that the coding features of JEM 3 are implemented in JEM reference software maintained by the Fraunhofer research organization. Currently, the updated JEM reference software version 3 (JEM 3.0) is available. As used herein, the term JEM is used to collectively refer to algorithms included in JEM 3 and implementations of JEM reference software.

Video compression techniques enable data requirements for storing and transmitting video data to be reduced. Video compression techniques may reduce data requirements by exploiting the inherent redundancies in a video sequence. Video compression techniques may sub-divide a video sequence into successively smaller portions (i.e., groups of frames within a video sequence, a frame within a group of frames, slices within a frame, coding tree units (e.g., macroblocks) within a slice, coding blocks within a coding tree unit, etc.). Intra prediction coding techniques (e.g., intra-picture (spatial)) and inter prediction techniques (i.e., inter-picture (temporal)) may be used to generate difference values between a unit of video data to be coded and a reference unit of video data. The difference values may be referred to as residual data. Residual data may be coded as quantized transform coefficients. Syntax elements may relate residual data and a reference coding unit (e.g., intra-prediction mode indices, motion vectors, and block vectors). Residual data and syntax elements may be entropy coded. Entropy encoded residual data and syntax elements may be included in a compliant bitstream.

### SUMMARY OF INVENTION

In one example, a method of partitioning video data for video coding, comprises receiving a video block including sample values for a component of video data, partitioning the video block according to a partitioning line defined according to an angle and an distance, and signaling the partitioning line based on allowed values for the angle and the distance, wherein the allowed values are based on one or more of properties of video data or video coding parameters.

In one example, a method of reconstructing video data comprises determining residual data for a video block, determining allowed values for an angle and distance, wherein the allowed values are based on one or more of properties of video data or video coding parameters, parsing one or more syntax elements indicating values for the angle and the distance, determining a partitioning line based on the indicated values for the angle and the distance, for each partition resulting from the determined partitioning line, generating predictive video data, and reconstructing video data for the video block based on the residual data and the predictive video data.

### BRIEF DESCRIPTION OF DRAWINGS

FIG. 1 is a conceptual diagram illustrating an example of a group of pictures coded according to a quad tree binary tree partitioning in accordance with one or more techniques of this disclosure.

FIG. 2 is a conceptual diagram illustrating an example of a quad tree binary tree in accordance with one or more techniques of this disclosure.

FIG. 3 is a conceptual diagram illustrating video component quad tree binary tree partitioning in accordance with one or more techniques of this disclosure.

FIG. 4 is a conceptual diagram illustrating an example of a video component sampling format in accordance with one or more techniques of this disclosure.

FIG. 5 is a conceptual diagram illustrating possible coding structures for a block of video data according to one or more techniques of this disclosure.

FIG. 6A is a conceptual diagram illustrating example of coding a block of video data in accordance with one or more techniques of this disclosure.

FIG. 6B is a conceptual diagram illustrating example of coding a block of video data in accordance with one or more techniques of this disclosure.

FIG. 7 is a conceptual diagram illustrating an example of an object boundary included in a video block of an image in accordance with one or more techniques of this disclosure.

FIG. 8 is a conceptual diagram illustrating an example of asymmetric motion partitioning for coding the object boundary illustrated in FIG. 7.

FIG. 9 is a conceptual diagram illustrating an example of a quad tree binary tree partition for coding the object boundary illustrated in FIG. 7.

FIG. 10 is a block diagram illustrating an example of a system that may be configured to encode and decode video data according to one or more techniques of this disclosure.

FIG. 11 is a block diagram illustrating an example of a video encoder that may be configured to encode video data according to one or more techniques of this disclosure.

FIG. 12 is a conceptual diagram illustrating geometry-adaptive block partitioning in accordance with one or more techniques of this disclosure.

FIG. 13 is a conceptual diagram illustrating geometry-adaptive block partitioning in accordance with one or more techniques of this disclosure.

FIG. 14 is a conceptual diagram illustrating geometry-adaptive block partitioning in accordance with one or more techniques of this disclosure.

FIG. 15 is a conceptual diagram illustrating geometry-adaptive block partitioning in accordance with one or more techniques of this disclosure.

FIG. 16 is a block diagram illustrating an example of a video decoder that may be configured to decode video data according to one or more techniques of this disclosure.

### DESCRIPTION OF EMBODIMENTS

In general, this disclosure describes various techniques for coding video data. In particular, this disclosure describes techniques for partitioning a picture of video data. It should be noted that although techniques of this disclosure are described with respect to ITU-T H.264, ITU-T H.265, and JEM, the techniques of this disclosure are generally applicable to video coding. For example, the coding techniques described herein may be incorporated into video coding systems, (including video coding systems based on future video coding standards) including block structures, intra prediction techniques, inter prediction techniques, transform techniques, filtering techniques, and/or entropy coding techniques other than those included in ITU-T H.265 and JEM. Thus, reference to ITU-T H.264, ITU-T H.265, and/or JEM is for descriptive purposes and should not be construed to limit the scope of the techniques described herein. Further, it should be noted that incorporation by reference of documents herein is for descriptive purposes and should not be construed to limit or create ambiguity with respect to terms used herein. For example, in the case where an incorporated reference provides a different definition of a term than another incorporated reference and/or as the term is used herein, the term should be interpreted in a manner that broadly includes each respective definition and/or in a manner that includes each of the particular definitions in the alternative.

In one example, a device for partitioning video data for video coding comprises one or more processors configured to receive a video block including sample values for a component of video data, partition the video block according to a partitioning line defined according to an angle and an distance, and signal the partitioning line based on allowed values for the angle and the distance, wherein the allowed values are based on one or more of properties of video data or video coding parameters.

In one example, a non-transitory computer-readable storage medium comprises instructions stored thereon that, when executed, cause one or more processors of a device to receive a video block including sample values for a component of video data, partition the video block according to a partitioning line defined according to an angle and an distance, and signal the partitioning line based on allowed values for the angle and the distance, wherein the allowed values are based on one or more of properties of video data or video coding parameters.

In one example, an apparatus comprises means for receiving a video block including sample values for a component of video data, means for partitioning the video block according to a partitioning line defined according to an angle and an distance, and means for signaling the partitioning line based on allowed values for the angle and the distance, wherein the allowed values are based on one or more of properties of video data or video coding parameters.

In one example, a device for reconstructing video data comprises one or more processors configured to determine residual data for a video block, determine allowed values for an angle and distance, wherein the allowed values are based on one or more of properties of video data or video coding parameters, parse one or more syntax elements indicating values for the angle and the distance, determine a partitioning line based on the indicated values for the angle and the distance, for each partition resulting from the determined partitioning line, generate predictive video data, and reconstruct video data for the video block based on the residual data and the predictive video data.

In one example, a non-transitory computer-readable storage medium comprises instructions stored thereon that, when executed, cause one or more processors of a device to determine residual data for a video block, determine allowed values for an angle and distance, wherein the allowed values are based on one or more of properties of video data or video coding parameters, parse one or more syntax elements indicating values for the angle and the distance, determine a partitioning line based on the indicated values for the angle and the distance, for each partition resulting from the determined partitioning line, generate predictive video data, and reconstruct video data for the video block based on the residual data and the predictive video data.

In one example, an apparatus comprises means for determining residual data for a video block, means for determining allowed values for an angle and distance, wherein the allowed values are based on one or more of properties of video data or video coding parameters, means for parsing one or more syntax elements indicating values for the angle and the distance, means for determining a partitioning line based on the indicated values for the angle and the distance, means for for each partition resulting from the determined partitioning line, generating predictive video data, and reconstructing video data for the video block based on the residual data and the predictive video data.

The details of one or more examples are set forth in the accompanying drawings and the description below. Other features, objects, and advantages will be apparent from the description and drawings, and from the claims.

Video content typically includes video sequences comprised of a series of frames (or pictures). A series of frames may also be referred to as a group of pictures (GOP). Each video frame or picture may include a plurality of slices or tiles, where a slice or tile includes a plurality of video blocks. As used herein, the term video block may generally refer to an area of a picture or may more specifically refer to the largest array of sample values that may be predictively coded, sub-divisions thereof, and/or corresponding structures. Further, the term current video block may refer to an area of a picture being encoded or decoded. A video block may be defined as an array of sample values that may be predictively coded. It should be noted that in some cases pixel values may be described as including sample values for respective components of video data, which may also be referred to as color components, (e.g., luma (Y) and chroma (Cb and Cr) components or red, green, and blue components). It should be noted that in some cases, the terms pixel values and sample values are used interchangeably. Video blocks may be ordered within a picture according to a scan pattern (e.g., a raster scan). A video encoder may perform predictive encoding on video blocks and sub-divisions thereof. Video blocks and sub-divisions thereof may be referred to as nodes.

ITU-T H.264 specifies a macroblock including 16×16 luma samples. That is, in ITUT H.264, a picture is segmented into macroblocks. Marcoblocks ITU-T H.265 specifies an analogous Coding Tree Unit (CTU) structure. In ITU-T H.265, pictures are segmented into CTUs. In ITU-T H.265, for a picture, a CTU size may be set as including 16×16, 32×32, or 64×64 luma samples. In ITU-T H.265, a CTU is composed of respective Coding Tree Blocks (CTB) for each component of video data (e.g., luma (Y) and chroma (Cb and Cr). Further, in ITU-T H.265, a CTU may be partitioned according to a quadtree (QT) partitioning structure, which results in the CTBs of the CTU being partitioned into Coding Blocks (CB). That is, in ITU-T H.265, a CTU may be partitioned into quadtree leaf nodes. According to ITU-T H.265, one luma CB together with two corresponding chroma CBs and associated syntax elements are referred to as a coding unit (CU). In ITU-T H.265, a minimum allowed size of a CB may be signaled. In ITU-T H.265, the smallest minimum allowed size of a luma CB is 8×8 luma samples. In ITU-T H.265, the decision to code a picture area using intra prediction or inter prediction is made at the CU level.

In ITU-T H.265, a CU is associated with a prediction unit (PU) structure having its root at the CU. In ITU-T H.265, PU structures allow luma and chroma CBs to be split for purposes of generating corresponding reference samples. That is, in ITU-T H.265, luma and chroma CBs may be split into respect luma and chroma prediction blocks (PBs), where a PB includes a block of sample values for which the same prediction is applied. In ITU-T H.265, a CB may be partitioned into one, two, or four PBs. ITU-T H.265 supports PB sizes from 64×64 samples down to 4×4 samples. In ITU-T H.265, square PBs are supported for intra prediction, where a CB may form the PB or the CB may be split into four square PBs (i.e., intra prediction PB types include MxM or M/2×M/2, where M is the height and width of the square CB). In ITU-T H.265, in addition to the square PBs, rectangular PBs are supported for inter prediction, where a CB may by halved vertically or horizontally to form PBs (i.e., inter prediction PB types include M×M, M/2×M/2, M/2×M, or M×M/2). Further, in ITU-T H.265, for inter prediction, four asymmetric PB partitions are supported, where the CB is partitioned into two PBs at one quarter of the height (at the top or the bottom) or width (at the left or the right) of the CB (i.e., asymmetric partitions include M/4×M left, M/4×M right, M×M/4 top, and M×M/4 bottom). It should be noted that in ITU-T H.264, for intra prediction, a 16×16 macroblock may be further partitioned into four 8×8 blocks or 16 4×4 blocks and for inter prediction, a 16×16 macroblock may be further partitioned into two 16×8 blocks, two 8×16 blocks, four 8×8 blocks, where each 8×8 block may be further partitioned into 8×4 blocks or 4×8 blocks, or 16 4×4 blocks. Intra prediction data (e.g., intra prediction mode syntax elements) or inter prediction data (e.g., motion data syntax elements) corresponding to a PB is used to produce reference and/or predicted sample values for the PB.

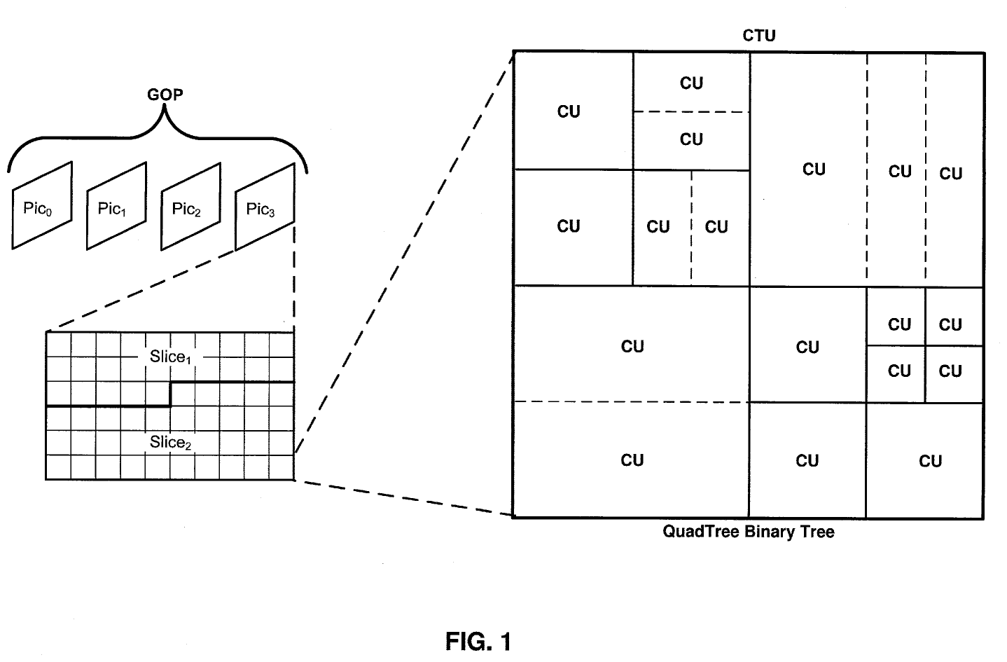

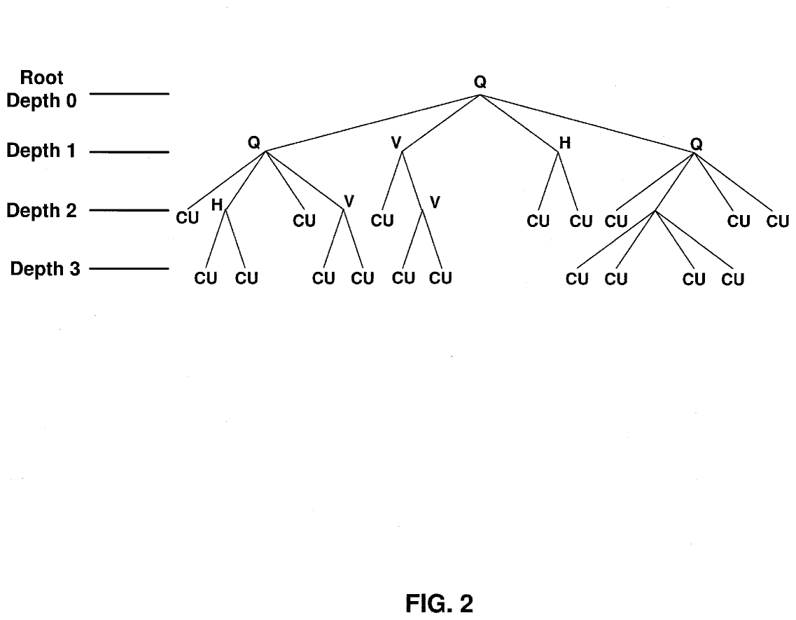

JEM specifies a CTU having a maximum size of 256×256 luma samples. JEM specifies a quadtree plus binary tree (QTBT) block structure. In JEM, the QTBT structure enables quadtree leaf nodes to be further partitioned by a binary tree (BT) structure. That is, in JEM, the binary tree structure enables quadtree leaf nodes to be recursively divided vertically or horizontally. FIG. 1 illustrates an example of a CTU (e.g., a CTU having a size of 256×256 luma samples) being partitioned into quadtree leaf nodes and quadtree leaf nodes being further partitioned according to a binary tree. That is, in FIG. 1 dashed lines indicate additional binary tree partitions in a quadtree. Thus, the binary tree structure in JEM enables square and rectangular leaf nodes, where each leaf node includes a CB. As illustrated in FIG. 1, a picture included in a GOP may include slices, where each slice includes a sequence of CTUs and each CTU may be partitioned according to a QTBT structure. FIG. 1 illustrates an example of QTBT partitioning for one CTU included in a slice. FIG. 2 is a conceptual diagram illustrating an example of a QTBT corresponding to the example QTBT partition illustrated in FIG. 1.

In JEM, a QTBT is signaled by signaling QT split flag and BT split mode syntax elements. When a QT split flag has a value of 1, a QT split is indicated. When a QT split flag has a value of 0, a BT split mode syntax element is signaled. When a BT split mode syntax element has a value of 0 (i.e., BT split mode coding tree=0), no binary splitting is indicated. When a BT split mode syntax element has a value of 1 (i.e., BT split mode coding tree=11), a vertical split mode is indicated. When a BT split mode syntax element has a value of 2 (i.e., BT split mode coding tree=10), a horizontal split mode is indicated. Further, BT splitting may be performed until a maximum BT depth is reached.

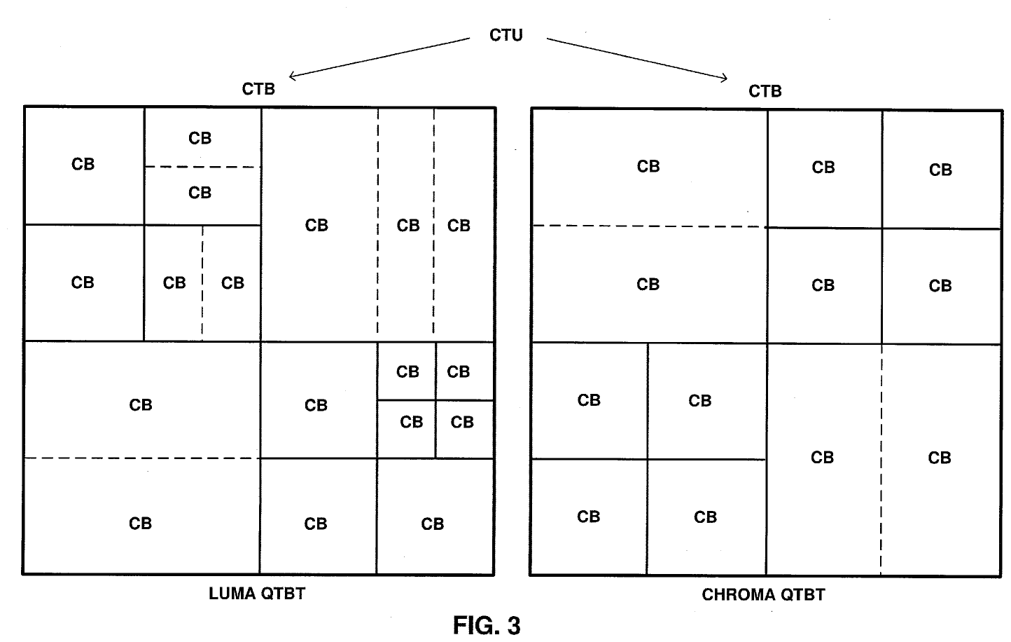

Further, in JEM, luma and chroma components may have separate QTBT partitions. That is, in JEM luma and chroma components may be partitioned independently by signaling respective QTBTs. FIG. 3 illustrates an example of a CTU being partitioned according to a QTBT for a luma component and an independent QTBT for chroma components. As illustrated in FIG. 3, when independent QTBTs are used for partitioning a CTU, CBs of the luma component are not required to and do not necessarily align with CBs of chroma components. Currently, in JEM independent QTBT structures are enabled for slices using intra prediction techniques. It should be noted that in some cases, values of chroma variables may need to be derived from the associated luma variable values. In these cases, the sample position in chroma and chroma format may be used to determine the corresponding sample position in luma to determine the associated luma variable value.

Additionally, it should be noted that JEM includes the following parameters for signaling of a QTBT tree:
CTU size: the root node size of a quadtree (e.g., 256×256, 128×128, 64×64, 32×32, 16×16 luma samples);
MinQTSize: the minimum allowed quadtree leaf node size (e.g., 16×16, 8×8 luma samples);
MaxBTSize: the maximum allowed binary tree root node size, i.e., the maximum size of a leaf quadtree node that may be partitioned by binary splitting (e.g., 64×64 luma samples);
MaxBTDepth: the maximum allowed binary tree depth, i.e., the lowest level at which binary splitting may occur, where the quadtree leaf node is the root (e.g., 3);
MinBTSize: the minimum allowed binary tree leaf node size; i.e., the minimum width or height of a binary leaf node (e.g., 4 luma samples).

It should be noted that in some examples, MinQTSize, MaxBTSize, MaxBTDepth, and/or MinBTSize may be different for the different components of video.

In JEM, CBs are used for prediction without any further partitioning. That is, in JEM, a CB may be a block of sample values on which the same prediction is applied. Thus, a JEM QTBT leaf node may be analogous a PB in ITU-T H.265.

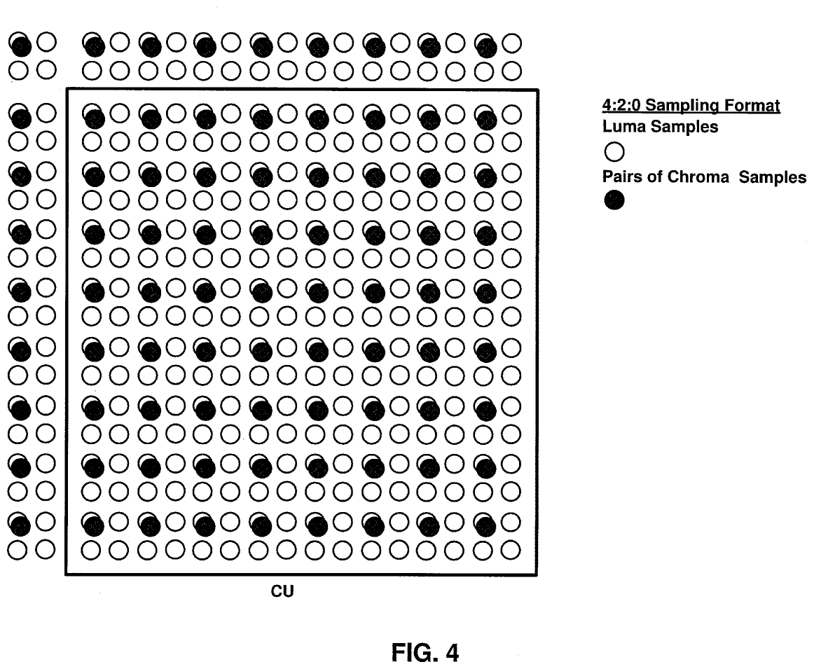

A video sampling format, which may also be referred to as a chroma format, may define the number of chroma samples included in a CU with respect to the number of luma samples included in a CU. For example, for the 4:2:0 sampling format, the sampling rate for the luma component is twice that of the chroma components for both the horizontal and vertical directions. As a result, for a CU formatted according to the 4:2:0 format, the width and height of an array of samples for the luma component are twice that of each array of samples for the chroma components. FIG. 4 is a conceptual diagram illustrating an example of a coding unit formatted according to a 4:2:0 sample format. FIG. 4 illustrates the relative position of chroma samples with respect to luma samples within a CU. As described above, a CU is typically defined according to the number of horizontal and vertical luma samples. Thus, as illustrated in FIG. 4, a 16×16 CU formatted according to the 4:2:0 sample format includes 16×16 samples of luma components and 8×8 samples for each chroma component. Further, in the example illustrated in FIG. 4, the relative position of chroma samples with respect to luma samples for video blocks neighboring the 16×16 CU are illustrated. For a CU formatted according to the 4:2:2 format, the width of an array of samples for the luma component is twice that of the width of an array of samples for each chroma component, but the height of the array of samples for the luma component is equal to the height of an array of samples for each chroma component. Further, for a CU formatted according to the 4:4:4 format, an array of samples for the luma component has the same width and height as an array of samples for each chroma component.

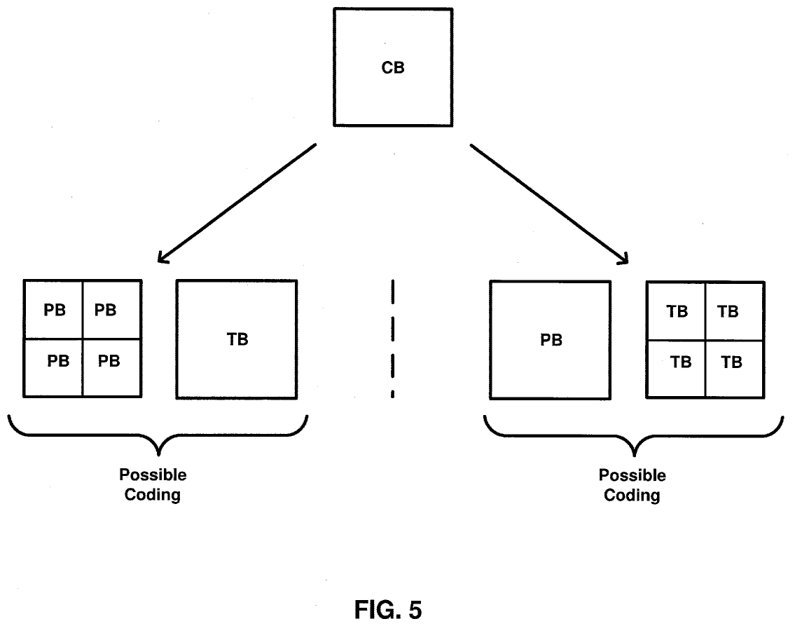

As described above, intra prediction data or inter prediction data is used to produce reference sample values for a block of sample values. The difference between sample values included in a current PB, or another type of picture area structure, and associated reference samples (e.g., those generated using a prediction) may be referred to as residual data. Residual data may include respective arrays of difference values corresponding to each component of video data. Residual data may be in the pixel domain. A transform, such as, a discrete cosine transform (DCT), a discrete sine transform (DST), an integer transform, a wavelet transform, or a conceptually similar transform, may be applied to an array of difference values to generate transform coefficients. It should be noted that in ITU-T H.265, a CU is associated with a transform unit (TU) structure having its root at the CU level. That is, in ITU-T H.265, an array of difference values may be sub-divided for purposes of generating transform coefficients (e.g., four 8×8 transforms may be applied to a 16×16 array of residual values). For each component of video data, such sub-divisions of difference values may be referred to as Transform Blocks (TBs). It should be noted that in ITU-T H.265, TBs are not necessarily aligned with PBs. FIG. 5 illustrates examples of alternative PB and TB combinations that may be used for coding a particular CB. Further, it should be noted that in ITU-T H.265, TBs may have the following sizes 4×4, 8×8, 16×16, and 32×32.

It should be noted that in JEM, residual values corresponding to a CB are used to generate transform coefficients without further partitioning. That is, in JEM a QTBT leaf node may be analogous to both a PB and a TB in ITU-T H.265. It should be noted that in JEM, a core transform and a subsequent secondary transforms may be applied (in the video encoder) to generate transform coefficients. For a video decoder, the order of transforms is reversed. Further, in JEM, whether a secondary transform is applied to generate transform coefficients may be dependent on a prediction mode.

A quantization process may be performed on transform coefficients. Quantization may be generally described as scaling transform coefficients in order to vary the amount of data required to represent a group of transform coefficients. Quantization may include division of transform coefficients by a quantization scaling factor and any associated rounding functions (e.g., rounding to the nearest integer). Quantized transform coefficients may be referred to as coefficient level values. Inverse quantization (or “dequantization”) may include multiplication of coefficient level values by the quantization scaling factor. It should be noted that as used herein the term quantization process in some instances may refer to division by a scaling factor to generate level values and multiplication by a scaling factor to recover transform coefficients in some instances. That is, a quantization process may refer to quantization in some cases and inverse quantization in some cases. Further, it should be noted that although in the examples below quantization processes are described with respect to arithmetic operations associated with decimal notation, such descriptions are for illustrative purposes and should not be construed as limiting. For example, the techniques described herein may be implemented in a device using binary operations and the like. For example, multiplication and division operations described herein may be implemented using bit shifting operations and the like.

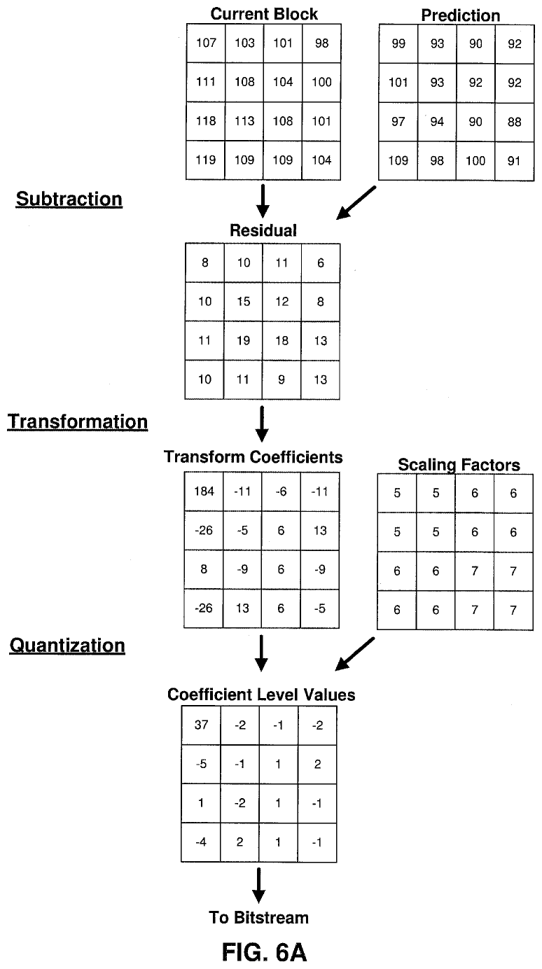

FIGS. 6A-6B are conceptual diagrams illustrating examples of coding a block of video data. As illustrated in FIG. 6A, a current block of video data (e.g., a CB corresponding to a video component) is encoded by generating a residual by subtracting a set of prediction values from the current block of video data, performing a transformation on the residual, and quantizing the transform coefficients (i.e., by scaling using an array of scaling factors) to generate level values. As illustrated in FIG. 6B, the current block of video data is decoded by performing inverse quantization on level values, performing an inverse transform, and adding a set of prediction values to the resulting residual. It should be noted that in the examples in FIGS. 6A-6B, the sample values of the reconstructed block differs from the sample values of the current video block that is encoded. In this manner, coding may said to be lossy. However, the difference in sample values may be considered acceptable to a viewer of the reconstructed video.

It should be noted that in ITU-T H.265, for quantization, an array of scaling factors is generated by selecting a scaling matrix and multiplying each entry in the scaling matrix by a quantization scaling factor. In ITU-T H.265, a scaling matrix is selected based on a prediction mode and a color component, where scaling matrices of the following sizes are defined: 4×4, 8×8, 16×16, and 32×32. In ITU-T H.265, the value of a quantization scaling factor, may be determined by a quantization parameter, QP. In ITU-T H.265, the QP can take 52 values from 0 to 51 and a change of 1 for QP generally corresponds to a change in the value of the quantization scaling factor by approximately 12%. Further, in ITU-T H.265, a QP value for a set of transform coefficients may be derived using a predictive quantization parameter value (which may be referred to as a predictive QP value or a QP predictive value) and an optionally signaled quantization parameter delta value (which may be referred to as a QP delta value or a delta QP value). In ITU-T H.265, a quantization parameter may be updated for each CU and a quantization parameter may be derived for each of luma (Y) and chroma (Cb and Cr) components.

As illustrated in FIG. 6A, quantized transform coefficients are coded into a bitstream. Quantized transform coefficients and syntax elements (e.g., syntax elements indicating a coding structure for a video block) may be entropy coded according to an entropy coding technique. Examples of entropy coding techniques include content adaptive variable length coding (CAVLC), context adaptive binary arithmetic coding (CABAC), probability interval partitioning entropy coding (PIPE), and the like. Entropy encoded quantized transform coefficients and corresponding entropy encoded syntax elements may form a compliant bitstream that can be used to reproduce video data at a video decoder. An entropy coding process may include performing a binarization on syntax elements. Binarization refers to the process of converting a value of a syntax value into a series of one or more bits. These bits may be referred to as “bins.” Binarization is a lossless process and may include one or a combination of the following coding techniques: fixed length coding, unary coding, truncated unary coding, truncated Rice coding, Golomb coding, k-th order exponential Golomb coding, and Golomb-Rice coding. For example, binarization may include representing the integer value of 5 for a syntax element as 00000101 using an 8-bit fixed length binarization technique or representing the integer value of 5 as 11110 using a unary coding binarization technique. As used herein each of the terms fixed length coding, unary coding, truncated unary coding, truncated Rice coding, Golomb coding, k-th order exponential Golomb coding, and Golomb-Rice coding may refer to general implementations of these techniques and/or more specific implementations of these coding techniques. For example, a Golomb-Rice coding implementation may be specifically defined according to a video coding standard, for example, ITU-T H.265. An entropy coding process further includes coding bin values using lossless data compression algorithms. In the example of a CABAC, for a particular bin, a context model may be selected from a set of available context models associated with the bin. In some examples, a context model may be selected based on a previous bin and/or values of previous syntax elements. A context model may identify the probability of a bin having a particular value. For instance, a context model may indicate a 0.7 probability of coding a 0-valued bin and a 0.3 probability of coding a 1-valued bin. It should be noted that in some cases the probability of coding a 0-valued bin and probability of coding a 1-valued bin may not sum to 1. After selecting an available context model, a CABAC entropy encoder may arithmetically code a bin based on the identified context model. The context model may be updated based on the value of a coded bin. The context model may be updated based on an associated variable stored with the context, e.g., adaptation window size, number of bins coded using the context. It should be noted, that according to ITU-T H.265, a CABAC entropy encoder may be implemented, such that some syntax elements may be entropy encoded using arithmetic encoding without the usage of an explicitly assigned context model, such coding may be referred to as bypass coding.

As described above, intra prediction data or inter prediction data may associate an area of a picture (e.g., a PB or a CB) with corresponding reference samples. For intra prediction coding, an intra prediction mode may specify the location of reference samples within a picture. In ITU-T H.265, defined possible intra prediction modes include a planar (i.e., surface fitting) prediction mode (predMode: 0), a DC (i.e., flat overall averaging) prediction mode (predMode: 1), and 33 angular prediction modes (predMode: 2-34). In JEM, defined possible intra-prediction modes include a planar prediction mode (predMode: 0), a DC prediction mode (predMode: 1), and 65 angular prediction modes (predMode: 2-66). It should be noted that planar and DC prediction modes may be referred to as non-directional prediction modes and that angular prediction modes may be referred to as directional prediction modes. It should be noted that the techniques described herein may be generally applicable regardless of the number of defined possible prediction modes.

For inter prediction coding, a motion vector (MV) identifies reference samples in a picture other than the picture of a video block to be coded and thereby exploits temporal redundancy in video. For example, a current video block may be predicted from reference block(s) located in previously coded frame(s) and a motion vector may be used to indicate the location of the reference block. A motion vector and associated data may describe, for example, a horizontal component of the motion vector, a vertical component of the motion vector, a resolution for the motion vector (e.g., onequarter pixel precision, one-half pixel precision, one-pixel precision, two-pixel precision, four-pixel precision), a prediction direction and/or a reference picture index value. Further, a coding standard, such as, for example ITU-T H.265, may support motion vector prediction. Motion vector prediction enables a motion vector to be specified using motion vectors of neighboring blocks. Examples of motion vector prediction include advanced motion vector prediction (AMVP), temporal motion vector prediction (TMVP), so-called “merge” mode, and “skip” and “direct” motion inference. Further, JEM supports advanced temporal motion vector prediction (ATMVP) and Spatial-temporal motion vector prediction (STMVP).

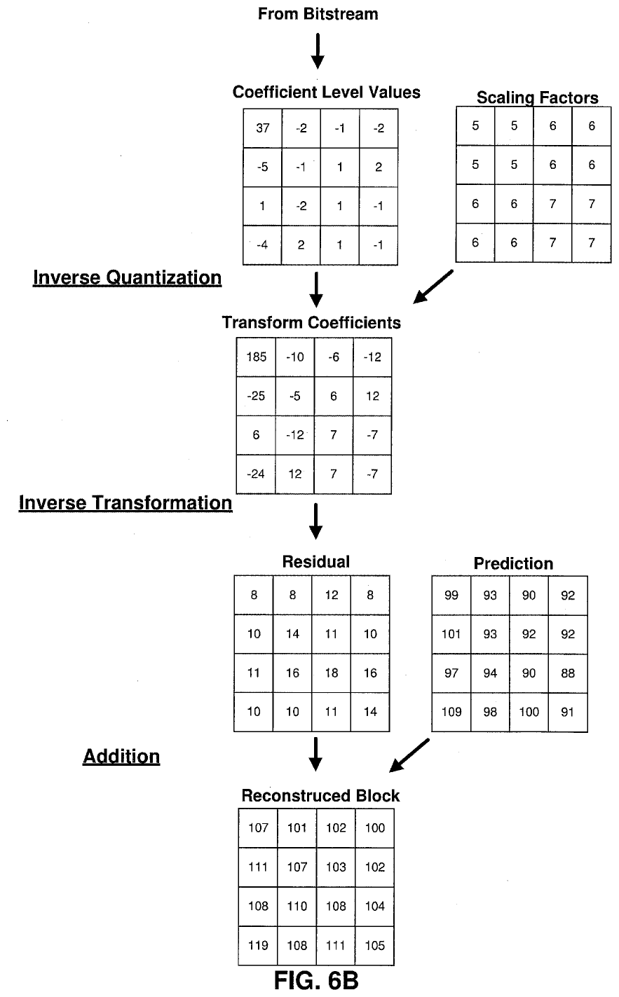

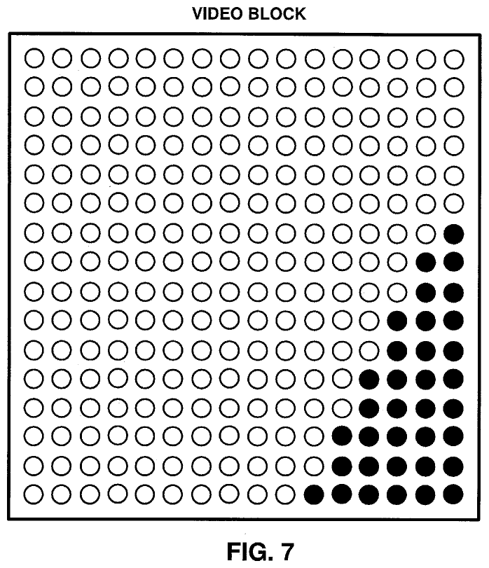

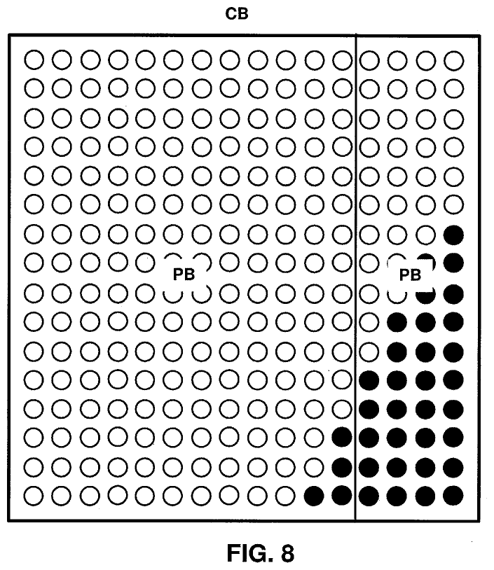

As described above, in ITU-T H.264, ITU-T H.265, and JEM, partitioning a video block for generating a prediction is limited to rectangular shaped partitioning. Such partitioning may be less than ideal, as edges occurring in images do not generally align with rectangular boundaries. That is, edges in an image may be defined according to various geometries (e.g., lines having various orientations, arcs, etc.). FIG. 7 illustrates an example of an object boundary included in a video block of an image. That is, in FIG. 7, the sample values illustrated as white form part of a first object and the sample values illustrated as black form part of a second object. The edge in FIG. 7 may be described as an arc or an diagonal line. As described above, for inter prediction, ITU-T H.265 supports four asymmetric PB partitions for inter prediction. FIG. 8 illustrates an example where the video block in FIG. 7 is partitioned using the M/4×M right partition. As illustrated in FIG. 8, the M/4×M right partition does not align with the edge of the image. Further, in ITU-T H.265, the M/4×M right partition is not available for intra prediction. Thus, partitioning in ITU-T H.265 may be less than ideal for edges occurring in images. As described above, in JEM, a QTBT leaf node, which allows for arbitrary rectangular CBs, may be analogous to both a PB and a TB in ITU-T H.265. FIG. 9 illustrates an example where the video block in FIG. 7 is partitioned using a QTBT. As illustrated in FIG. 9, although the second object is generally included in a BT leaf node, the first object is generally included in four CBs, which may create inefficiencies in coding (i.e., signaling overhead is incurred for each CB). Thus, partitioning in JEM may be less than ideal for edges occurring in images. This disclosure describes techniques for partitioning a picture according to geometry-adaptive partition shapes.

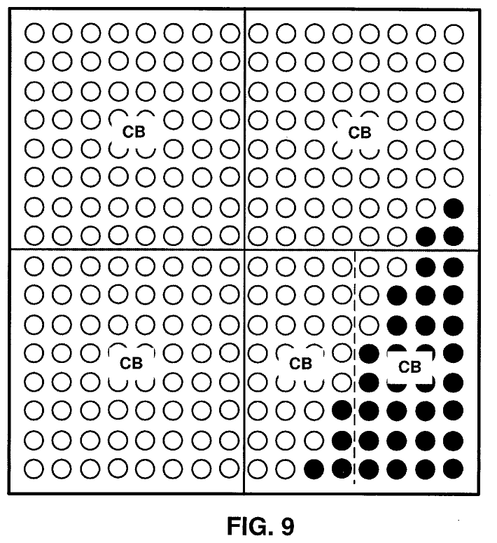

FIG. 10 is a block diagram illustrating an example of a system that may be configured to code (i.e., encode and/or decode) video data according to one or more techniques of this disclosure. System 100 represents an example of a system that may perform video coding using arbitrary rectangular video blocks according to one or more techniques of this disclosure. As illustrated in FIG. 10, system 100 includes source device 102, communications medium 110, and destination device 120. In the example illustrated in FIG. 10, source device 102 may include any device configured to encode video data and transmit encoded video data to communications medium 110. Destination device 120 may include any device configured to receive encoded video data via communications medium 110 and to decode encoded video data. Source device 102 and/or destination device 120 may include computing devices equipped for wired and/or wireless communications and may include set top boxes, digital video recorders, televisions, desktop, laptop, or tablet computers, gaming consoles, mobile devices, including, for example, “smart” phones, cellular telephones, personal gaming devices, and medical imagining devices.

Communications medium 110 may include any combination of wireless and wired communication media, and/or storage devices. Communications medium 110 may include coaxial cables, fiber optic cables, twisted pair cables, wireless transmitters and receivers, routers, switches, repeaters, base stations, or any other equipment that may be useful to facilitate communications between various devices and sites. Communications medium 110 may include one or more networks. For example, communications medium 110 may include a network configured to enable access to the World Wide Web, for example, the Internet. A network may operate according to a combination of one or more telecommunication protocols. Telecommunications protocols may include proprietary aspects and/or may include standardized telecommunication protocols. Examples of standardized telecommunications protocols include Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, Global System Mobile Communications (GSM) standards, code division multiple access (CDMA) standards, 3rd Generation Partnership Project (3GPP) standards, European Telecommunications Standards Institute (ETSI) standards, Internet Protocol (IP) standards, Wireless Application Protocol (WAP) standards, and Institute of Electrical and Electronics Engineers (IEEE) standards.

Storage devices may include any type of device or storage medium capable of storing data. A storage medium may include a tangible or non-transitory computer-readable media. A computer readable medium may include optical discs, flash memory, magnetic memory, or any other suitable digital storage media. In some examples, a memory device or portions thereof may be described as non-volatile memory and in other examples portions of memory devices may be described as volatile memory. Examples of volatile memories may include random access memories (RAM), dynamic random access memories (DRAM), and static random access memories (SRAM). Examples of non-volatile memories may include magnetic hard discs, optical discs, floppy discs, flash memories, or forms of electrically programmable memories (EPROM) or electrically erasable and programmable (EEPROM) memories. Storage device(s) may include memory cards (e.g., a Secure Digital (SD) memory card), internal/external hard disk drives, and/or internal/external solid state drives. Data may be stored on a storage device according to a defined file format.

Referring again to FIG. 10, source device 102 includes video source 104, video encoder 106, and interface 108. Video source 104 may include any device configured to capture and/or store video data. For example, video source 104 may include a video camera and a storage device operably coupled thereto. Video encoder 106 may include any device configured to receive video data and generate a compliant bitstream representing the video data. A compliant bitstream may refer to a bitstream that a video decoder can receive and reproduce video data therefrom. Aspects of a compliant bitstream may be defined according to a video coding standard. When generating a compliant bitstream video encoder 106 may compress video data. Compression may be lossy (discernible or indiscernible) or lossless. Interface 108 may include any device configured to receive a compliant video bitstream and transmit and/or store the compliant video bitstream to a communications medium. Interface 108 may include a network interface card, such as an Ethernet card, and may include an optical transceiver, a radio frequency transceiver, or any other type of device that can send and/or receive information. Further, interface 108 may include a computer system interface that may enable a compliant video bitstream to be stored on a storage device. For example, interface 108 may include a chipset supporting Peripheral Component Interconnect (PCI) and Peripheral Component Interconnect Express (PCIe) bus protocols, proprietary bus protocols, Universal Serial Bus (USB) protocols, I2C, or any other logical and physical structure that may be used to interconnect peer devices.

Referring again to FIG. 10, destination device 120 includes interface 122, video decoder 124, and display 126. Interface 122 may include any device configured to receive a compliant video bitstream from a communications medium. Interface 108 may include a network interface card, such as an Ethernet card, and may include an optical transceiver, a radio frequency transceiver, or any other type of device that can receive and/or send information. Further, interface 122 may include a computer system interface enabling a compliant video bitstream to be retrieved from a storage device. For example, interface 122 may include a chipset supporting PCI and PCIe bus protocols, proprietary bus protocols, USB protocols, I2C, or any other logical and physical structure that may be used to interconnect peer devices. Video decoder 124 may include any device configured to receive a compliant bitstream and/or acceptable variations thereof and reproduce video data therefrom. Display 126 may include any device configured to display video data. Display 126 may comprise one of a variety of display devices such as a liquid crystal display (LCD), a plasma display, an organic light emitting diode (OLED) display, or another type of display. Display 126 may include a High Definition display or an Ultra High Definition display. It should be noted that although in the example illustrated in FIG. 10, video decoder 124 is described as outputting data to display 126, video decoder 124 may be configured to output video data to various types of devices and/or sub-components thereof. For example, video decoder 124 may be configured to output video data to any communication medium, as described herein.

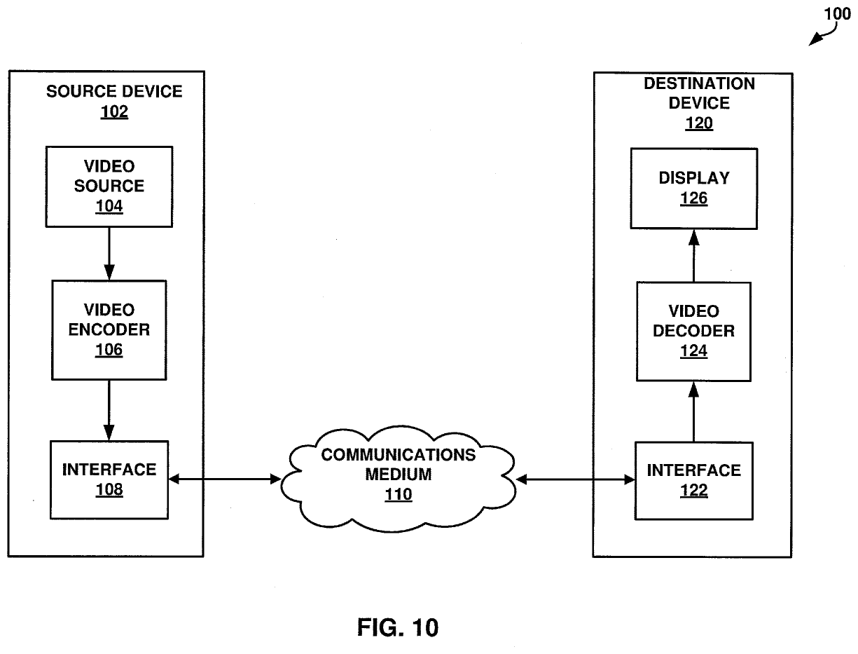

FIG. 11 is a block diagram illustrating an example of video encoder 200 that may implement the techniques for encoding video data described herein. It should be noted that although example video encoder 200 is illustrated as having distinct functional blocks, such an illustration is for descriptive purposes and does not limit video encoder 200 and/or sub-components thereof to a particular hardware or software architecture. Functions of video encoder 200 may be realized using any combination of hardware, firmware, and/or software implementations. In one example, video encoder 200 may be configured to encode video data according to the techniques described herein. Video encoder 200 may perform intra prediction coding and inter prediction coding of picture areas, and, as such, may be referred to as a hybrid video encoder. In the example illustrated in FIG. 11, video encoder 200 receives source video blocks. In some examples, source video blocks may include areas of picture that has been divided according to a coding structure. For example, source video data may include macroblocks, CTUs, CBs, sub-divisions thereof, and/or another equivalent coding unit. In some examples, video encoder 200 may be configured to perform additional subdivisions of source video blocks. It should be noted that some techniques described herein may be generally applicable to video coding, regardless of how source video data is partitioned prior to and/or during encoding. In the example illustrated in FIG. 11, video encoder 200 includes summer 202, transform coefficient generator 204, coefficient quantization unit 206, inverse quantization/transform processing unit 208, summer 210, intra prediction processing unit 212, inter prediction processing unit 214, post filter unit 216, and entropy encoding unit 218.

As illustrated in FIG. 11, video encoder 200 receives source video blocks and outputs a bitstream. As described above, partitioning techniques defined in ITU-T H.265 and in JEM may be less than ideal. For example, as described above with respect to FIGS. 7-9, the partitioning techniques in ITU-T H.265 and JEM may be less than ideal for generating predictions for edges occurring in images. Congxia Dai; Escoda, O.D.; Peng Yin; Xin Li; Gomila, C., “Geometry-Adaptive Block Partitioning for Intra Prediction in Image & Video Coding,” Image Processing, 2007. ICP 2007. IEEE International Conference on, vol. 6, no., pp. VI-85, VI-88, Sep. 16, 2007-Oct. 19, 2007 (hereinafter “Dai”) describes where a video block can be partitioned according to a partitioning line. In Dai, a partitioning line is generated by the zero level of:

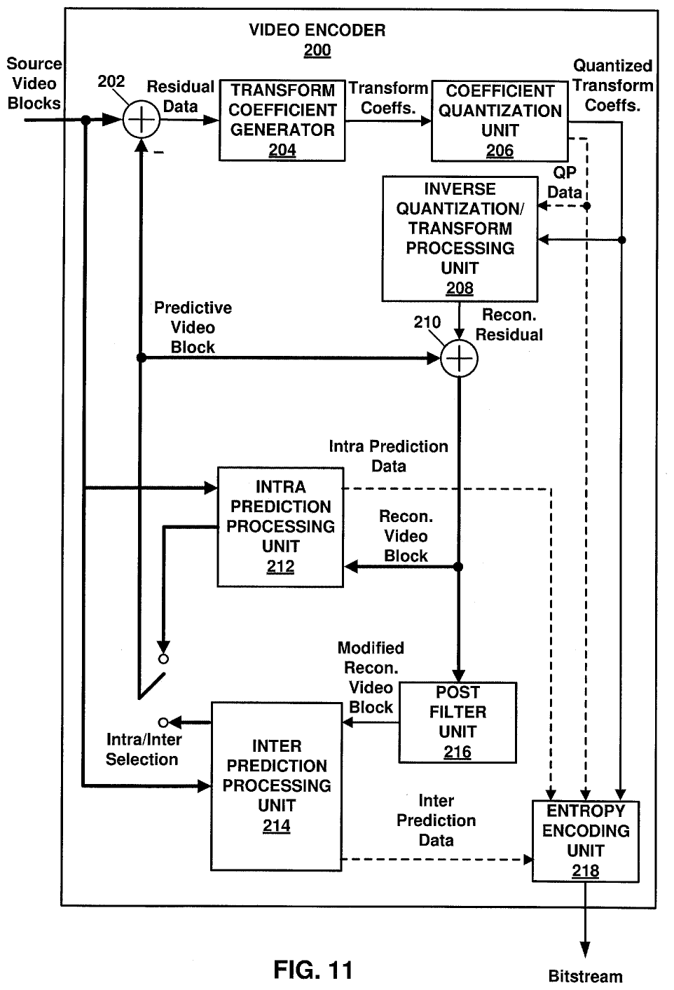

f(x,y)=x cos θ+y sin θ−ρ
where θ is an angle and p is a distance as illustrated in FIG. 12.

It should be noted that the partitioning line defined in Dai may cross some samples in a video block. Dai provides the following classification for each sample (x,y):
Partition (x,y)=if f(x, y)>0, Partition 0
   if f(x, y)=0, Line Boundary
   if f(x, y)<0, Partition 1

Dai provides where samples on the Line Boundary are referred as “partial surface” samples and are computed as a linear combination of their corresponding value if they were fully classified to each of the partitions. With respect to coding possible partitions, Dai provides where a dictionary of possible partitions is a priori defined such that
ρ: ρ∈[0, \sqrt{2}Block_{Size}/2), ρ∈{0, Δρ, 2Δρ, . . . };
θ∈[0, 2π), except when ρ=0, then θ∈[0, π);
Where Block_{Size} is length (or height) of a square video block; and
Δρ and Δθ are the selected sampling steps for ρ and θ, respectively.

It should be noted that with respect to Dai, Dai assumes that all video blocks to be partitioned are square and
Δρ
and
Δθ
are determined a priori. Further, Dai fails to provide semantics and/or syntax elements for signaling values of ρ and θ.

According to the techniques described herein, video encoder 200 may be configured to partition video blocks (e.g., partition a CB root into PBs) according to a partitioning line defined by ρ and θ and may further be configured to determine the resolution and/or distribution of ρ and θ values based on video characteristics and/or coding parameters. Further, video encoder 200 may be configured to signal values of ρ and θ (for use by a video decoder during decoding) according to one or more of the techniques described herein. In one example, video encoder 200 may be configured to signal the resolution and/or distribution of ρ and θ values at a CU level. In one example, signaling the resolution and/or distribution of ρ and θ values at a CU level may include signaling a syntax element indicating a set of possible p and θ values. In one example, a set of possible ρ and θ values may correspond to predefined partition shapes.

It should be noted that in contrast to Dai, in the examples described below, partitioning geometry is defined based on p having a range including negative integer values and π being the upper bound of θ. In one example, according to the techniques described herein, video encoder 200 may be configured such that the allowed values of ρ may be dependent on the size of a rectangular block. For example, for a video block (e.g., a CB) having a height, h, and a width w, the allowed values of ρ may be defined as follows:

$${ρ}_{m} = \frac{\sqrt{{h}^{2} + {w}^{2}}}{2} , \\ ρ ∈ \{ - floor ( {ρ}_{m} ) , … , - 2 , - 1 , 0 , 1 , 2 , … , floor ( {ρ}_{m} ) \}$$

Where floor(x) returns the greatest integer that is less than or equal to x.

According to this example, video encoder 200 may be configured to signal the value of ρ using a syntax element indicating the sign of ρ (e.g., a 1-bit flag indicating a positive or negative value) and one or more syntax elements indicating the absolute value of ρ. It should be noted that the binarization of the one or more syntax elements indicating the absolute value of ρ may depend on ρₘ. That is, in the example above, ρₘ determines the number of possible values for the absolute value of ρ and the number of possible values for the absolute value of ρ may determine a binarization of a syntax element representing the absolute value of ρ. For example, for a relatively small number of possible values for the absolute value of ρ, unary coding may be used, and for relative large number of possible values for the absolute value of ρ, fixed length coding may be used.

In one example, the allowed values of ρ may be dependent on block size and a maximum number of distinct ρ allowed. For example, for a video block having a height, h, and a width w, the allowed values of ρ may be defined as follows:

$${ρ}_{s} = min ( 1 , \frac{{ρ}_{m}}{127} ) , N = min ( floor ( {ρ}_{m} ) , 127 ) , {ρ}_{m} = \frac{\sqrt{{h}^{2} + {w}^{2}}}{2} , \\ ρ ∈ \{ - N {ρ}_{s} , … , - {ρ}_{s} , 0 , {ρ}_{s} , … , {N}_{{ρ}_{s}} \}$$

Where min (x,y) returns x, if x is less than or equal to y; else returns y.

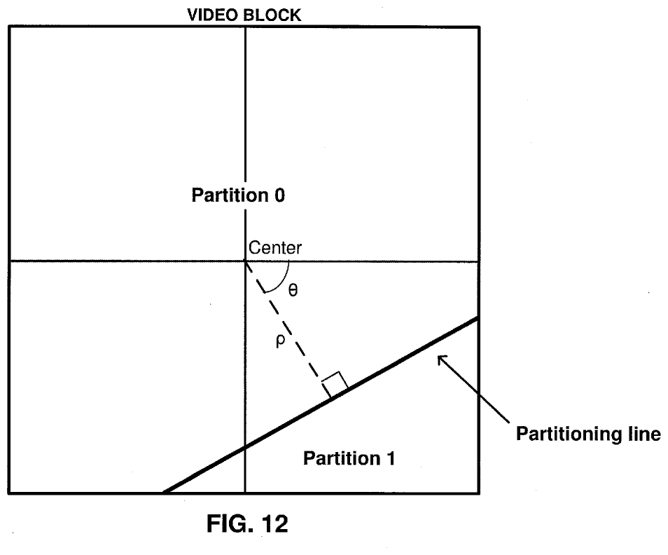

According to this example, video encoder 200 may be configured to signal the value of ρ using a syntax element indicating the sign of ρ and a syntax element indicating a value ranging from 0 to N. In a manner similar to the example described above, binarization of one or more syntax elements indicating a value ranging from 0 to N may depend on ρₘ, and/or ρₛ.
In one example, allowed values of ρ may include subsets of the sets defined above. For example, when ρ∈{−floor(ρₘ), . . . , −2,−1,0,1,2, . . . , floor(ρ,m)}, allowed values of ρ may be restricted to include integer multiples (e.g., ρ∈{−floor(ρₘ₋), . . . ,−2,0,2, . . . , floor(ρₘ)}, or ρ∈{−floor(ρₘ), . . . ,−4,0,4, . . . , floor(ρₘ)}). Further, in some examples, allowed values of ρ may include subsets having a non-linear distribution. FIG. 13 illustrates an example, where for a given θ value, possible partitioning lines are based on a non-linear distribution of ρ. That is, in the example illustrated in FIG. 13, the seven allowed values of ρ are not uniformly spaced from 0 to the maximum value of ρ. In one example, a non-linear distribution may include relatively denser sampling of ρ near 0. In one example, a non-linear distribution may include a relatively denser sampling of ρ in the allowed range when θ is closer to a vertical (or horizontal) value. Further, in one example, the allowed values of ρ may depend on the value of a quantization parameter (e.g., QP). For example, only relatively coarser resolutions of ρ may be allowed for higher QP. In one example, look-up tables (LUTs) may be defined for allowed values of ρ. For example, video encoder 200 may be configured to signal an index value corresponding to a LUT entry providing a value for ρ. In one example, a LUT may be determined based on based on video characteristics and/or coding parameters.

In one example, according to the techniques described herein, video encoder 200 may be configured such that the allowed values of θ may be dependent the size of a rectangular block. For example, in one example, for a video block having a height, h, and a width w, the allowed values of θ may be defined as follows:

$${θ}_{m} = h + w , θ ∈ \{ π * \frac{N}{{θ}_{m}} \} ; where N = 0 , 1 , 2 , … , ( {θ}_{m} - 1 )$$

In one example, for a video block having a height, h, and a width w, the allowed values of θ may be defined as follows:

$${θ}_{m} = ( h + w ) / 2 , θ ∈ \{ π * \frac{N}{{θ}_{m}} \} ; where N = 0 , 1 , 2 , … , ( {θ}_{m} - 1 )$$

In one example, according to the techniques described herein, video encoder 200 may be configured such that the allowed values of θ may be dependent on block size and a maximum number of distinct θ values allowed. For example, in one example, for a video block having a height, h, and a width w, the allowed values of θ may be defined as follows:

$${θ}_{m} = min ( h + w , 256 ) , θ ∈ \{ π * \frac{N}{{θ}_{m}} \} ;$$

$$where N = 0 , 1 , 2 , … , ( {θ}_{m} - 1 )$$

In one example, for a video block having a height, h, and a width w, the allowed values of θ may be defined as follows:

$${θ}_{m} = min ( \frac{h + w}{2} , 256 ) , θ ∈ \{ π * \frac{N}{{θ}_{m}} \} ;$$

$$where N = 0 , 1 , 2 , … , ( {θ}_{m} - 1 )$$

In a manner similar to that described above with respect to ρ, allowed values of θ may include subsets of the sets defined above and sets may include non-linear distributions. In one example, sets may be defined based on h and/or w. In one example, sets may be defined based on ρ. For example, in one example, θ may be more densely sampled when ρ is closer to the center of the block. In one example, θ may be more densely sampled within an allowed range nearer angles corresponding to vertical partitioning, horizontal partitioning, and/or diagonal partitioning. In one example, sets may be defined based on h, w, and/or ρ. In one example, video encoder 200 may be configured to perform binarization of θ based on h, w, and/or ρ. In one example, a syntax element corresponding to θ may be mapped to an angular value based on h, w, and/or ρ. Further, in one example, the allowed values of θ may depend on the value of QP. For example, only relatively coarser resolutions of θ may be allowed for higher QP. In one example, LUTs may be defined for allowed values of θ. For example, video encoder 200 may be configured to signal an index value corresponding to a LUT entry providing a value for θ. In one example, video encoder 200 may be configured to generate a bitstream where syntax elements providing the value of ρ precede the syntax elements providing the value for θ.

It should be noted that some θ and ρ combinations may be disallowed for non-square blocks because they do not provide a meaningful partition of a video block. For example, when h=4 and w=8, the combination ρ=3 and θ=0 does not have any impact on partitioning. When combinations are disallowed, signaling of θ and ρ may be modified accordingly to remove disallowed cases. In one example, allowed θ and ρ combination for a h and w combination may be signaled using index values. In one example, syntax elements providing the values ρ and θ may be signaled at a CU-level. That is, syntax elements providing the values ρ and θ may replace the syntax element part_mode in the Coding unit syntax provided in ITU-T H.265. For example, part_mode may be replaced with an index value corresponding to an allowed θ and ρ combination for a h and w combination. It should be noted that partition modes in ITUT H.265 may be represented by θ and ρ combinations. Thus, in some examples, an index value corresponding to an allowed θ and ρ combination may correspond to a partition mode defined in ITU-T H.265.

In one example, partition modes may be defined for θ and ρ. For example, in one example the allowed values of θ may depend on value of part_mode and a predetermined θₘ. For example, in one example, the following allowed θ values may be defined:

$$When part\_mode equals SIZE\_ 2 N \times 2 N\_rho \_theta \_precision 1 , \\ θ ∈ \{ π * \frac{N}{{θ}_{m}} \} where$$

$$N = 0 , 1 , 2 , … , ( {θ}_{m} - 1 ) [ coarser sampling ] ;$$

$$When part\_mode equals SIZE\_ 2 N \times 2 N\_rho \_theta \_precision 2 , \\ θ ∈ \{ π * \frac{N}{2 * {θ}_{m}} \} where N = 0 , 1 , 2 , … , 2 * ( {θ}_{m} - 1 ) ;$$

$$When part\_mode equals SIZE\_ 2 N \times 2 N\_rho \_theta \_precision 3 , \\ θ ∈ \{ π * \frac{N}{4 * {θ}_{m}} \} where$$

$$N = 0 , 1 , 2 , … , 4 * ( {θ}_{m} - 1 ) [ finer sampling ]$$

In a similar manner, the allowed values of ρ may depend on value of part_mode and a pre-determined ρₛ. For example, in one example, the following allowed ρ values may be defined:
When part_mode equals SIZE_2N×2N_rho_theta_precision1, ρ∈{ . . . , −4*ρₛ, 0,4*ρₛ, . . . }, the maximum and minimum value in the set are bounded [coarser sampling];
When part_mode equals SIZE_2N×2N_rho_theta_precision2, ρ∈{ . . . , −2*ρₛ, 0, 2*ρₛ, . . . } the maximum and minimum value in the set are bounded;
When part_mode equals SIZE_2N×2N_rho_theta_precision3, ρ∈{ . . . , −ρₛ, 0, ρₛ, . . . }, the maximum and minimum value in the set are bounded [finer sampling].
In one example, the maximum and minimum value in the set may be pre-determined values.
In one example, the maximum and minimum value in the set may depend on block size.

In this manner, video encoder 200 may be configured to determine the resolution of ρ and θ values based on video characteristics and/or coding parameters and signal p and θ values.

In one example, values of ρ and θ for a current block may be predictively coded based on values of ρ and θ of neighboring (spatial and/or temporal) blocks. In one example, values of ρ and θ of neighboring blocks may be used to generate a list. In one example, the first entry in the list is used as a predictor for ρ and θ values for the current block and a difference is signaled in the bitstream. In one example, if the list is empty a pre-determined values are used as a predictor for ρ and θ values for the current block and the difference is signaled/received in the bitstream. In one example, an index corresponding to an entry in the list is signaled and the ρ and θ values for the entry are used as a predictor for ρ and θ values for the current block and a difference is signaled in the bitstream. In one example, the list is fixed length. In this case, in one example, the list may be populated with entries only until there are available entries in the list. In one example, if the list is empty or has available entries, then a pre-determined set of parameter values may be used to populate the available entries in the list. In one example, the list may be pruned to remove duplicates. In one example, the list includes a complete set of allowed values and no difference values are signaled. In this manner, video encoder 200 may be configured to signal ρ and θ values using predictive coding techniques.

In one example, whether geometric partitioning enabled and/or used by a current block may be signaled in the bitstream. For example, for the QTBT structure described above, geometric partitioning may be enable or disabled for further partitioning leaf nodes. In one example, whether geometric partitioning is enabled may be based on a CTU size. In one example, whether geometric partitioning is enabled or disabled may be signaled using predictive coding techniques. For example, in a manner similar to that described above with respect to signaling ρ and θ values using predictive coding techniques, whether geometric partitioning is enabled or disabled for a neighboring block may be used to predictively code whether geometric partitioning is enabled or disabled for a current block.

Referring again to FIG. 12, in one example, according to the techniques described herein, each of Partition 0 and Partition 1 may form prediction blocks where predictions are generated for each block using spatial and/or temporally neighboring samples and each partition may use different prediction modes/information. In one example, in the case where samples are classified as belonging to a Line Boundary, the samples belonging to the Line Boundary may be predicted using a blending of the prediction blocks generated for each of Partition 0 and Partition 1. In one example, in the case of intra predication, in order to reduce complexity and to improve coding efficiency, for each of Partition 0 and Partition 1, available prediction modes may be restricted to a subset of defined possible intra prediction modes. For example, Partition 0 and Partition 1 may be restricted to a planar prediction mode, a DC prediction mode and/or a limited set of angular prediction modes (e.g., 4 out of 33).

In one example, video encoder 200 may be configured to partition a video block according to a partitioning line defined according f(x, y), described above, according to the following classification for each sample (x,y):
Partition (x,y)=if f(x, y)>0, Partition 0
   if f(x, y)<=0, Partition 1
That is, Line Boundary may be assigned to one of the partitions.

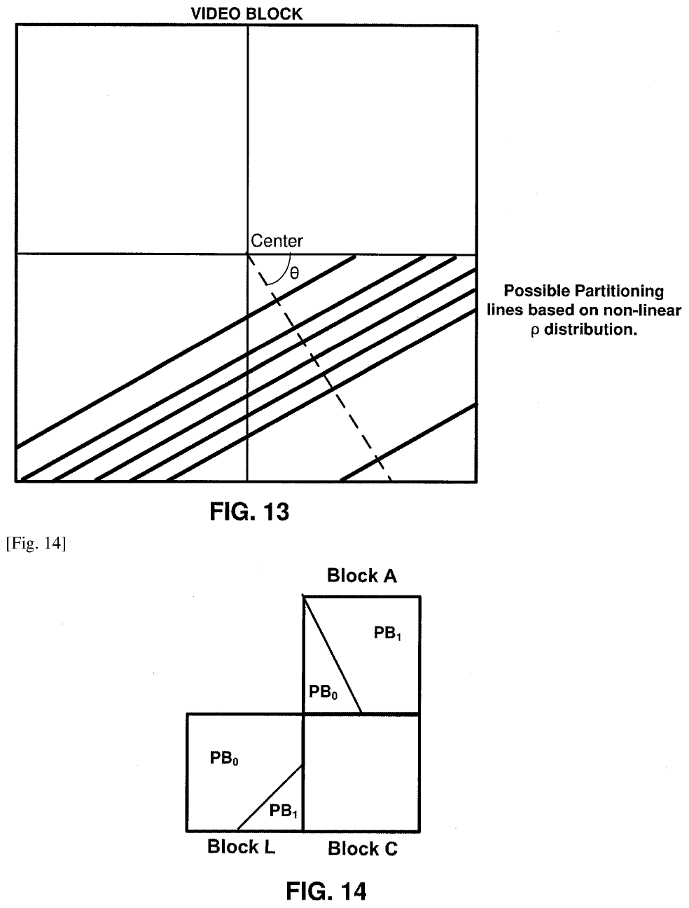

In one example, the neighboring block of a current block is geometrically partitioned (e.g., into Partition 0 and Partition 1) and available prediction modes for one of Partition 0 and Partition 1 are restricted (e.g., a neighboring Partition 1 is restricted to DC prediction modes), then the prediction for the current block may be based on of the prediction mode of the neighboring block may be used. FIG. 14 illustrates an example where a current block, Block C, has neighboring blocks formed by geometric partitions. In one example, if PB₁ in block L is restricted, then the prediction mode for the Block C may be based on of the prediction mode used for PB₀ in block L. In one example, when one of the partitions in geometric partitioning is restricted to particular prediction modes. An indication of which partition is restricted may be signaled in the bitstream. In one example, a neighboring block may be used to predictively code which partition is restricted.

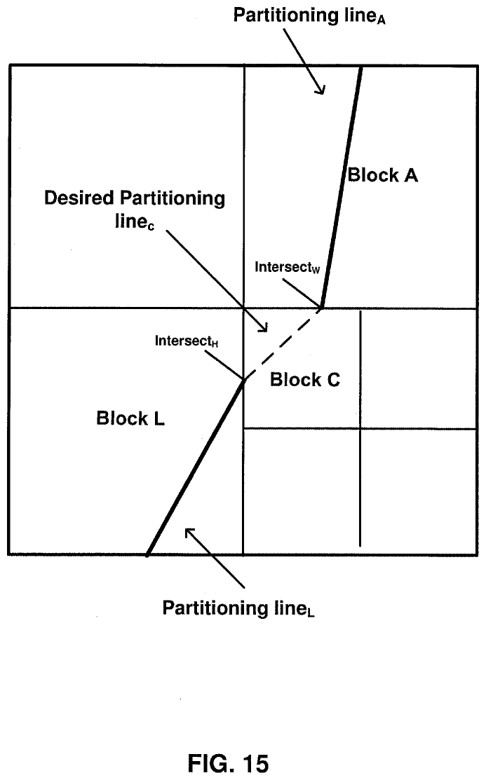

It should be noted that in some cases, edges in an image may extend into neighboring blocks generated according to a quadtree partitioning. In such cases, it may be desirable to effectively extend a partitioning line across neighboring blocks. For example, referring to FIG. 15, neighboring blocks Block L and Block A have partitioning lines corresponding to an edge in an image. For the current block, Block C, the desired partitioning line that effectively extends a partitioning line across neighboring blocks is illustrated. As described above, according to the techniques described herein, allowed values of ρ and θ may include subsets having a non-linear distribution. In one example, for a current block, a non-linear distribution of ρ and/or θ may include relatively denser samplings at values corresponding Intersect_{W} and Intersect_{H}. In this manner, the precision at which a partitioning line can be effectively extended across neighboring blocks can be increased. It should be noted that each of Intersect_{W} and Intersect_{H} in FIG. 15 may be determined by their respective dimensions and ρ and θ values.

In one example, a process for increasing the density of ρ and/or θ at values corresponding Intersect_{W} and Intersect_{H} may include (1) determining Intersect_{W} and Intersect_{H}; (2) selecting a set of allowed θ values where the angle of intersection between Partitioning line_{A} and Partitioning line_{L} and the desired partitioning line_{C} is more densely sampled. It should be Noted, that the angle of intersection does not depend on ρ; and (3) Once the set of allowed θ values is determined, selecting the allowed set of ρ for each θ. This may include, for example, defining a first ρ where the Partitioning line_{A} and Partitioning line_{L} divide the desired partitioning line_{C} line equally. In one example, ρ values may be more densely sampled nearer to the first p. Alternatively, in one example, ρ may be uniformly sampled. In this manner, video encoder 200 represents an example of a device configured to extend a partitioning line across neighboring blocks.

Referring again to FIG. 11, video encoder 200 may generate residual data by subtracting a predictive video block from a source video block. Summer 202 represents a component configured to perform this subtraction operation. In one example, the subtraction of video blocks occurs in the pixel domain. Transform coefficient generator 204 applies a transform, such as a discrete cosine transform (DCT), a discrete sine transform (DST), or a conceptually similar transform, to the residual block or subdivisions thereof (e.g., four 8×8 transforms may be applied to a 16×16 array of residual values) to produce a set of residual transform coefficients. Transform coefficient generator 204 may be configured to perform any and all combinations of the transforms included in the family of discrete trigonometric transforms. As described above, in ITU-T H.265, TBs are restricted to the following sizes 4×4, 8×8, 16×16, and 32×32. In one example, transform coefficient generator 204 may be configured to perform transformations according to arrays having sizes of 4×4, 8×8, 16×16, and 32×32. In one example, transform coefficient generator 204 may be further configured to perform transformations according to arrays having other dimensions. In particular, in some cases, it may be useful to perform transformations on rectangular arrays of difference values. In one example, transform coefficient generator 204 may be configured to perform transformations according to the following sizes of arrays: 2×2, 2×4N, 4M×2, and/or 4M×4N. In one example, a 2-dimensional (2D) M×N inverse transform may be implemented as 1-dimensional (1D) M-point inverse transform followed by a 1D N-point inverse transform. In one example, a 2D inverse transform may be implemented as a 1D N-point vertical transform followed by a 1D N-point horizontal transform. In one example, a 2D inverse transform may be implemented as a 1D N-point horizontal transform followed by a 1D N-point vertical transform. Transform coefficient generator 204 may output transform coefficients to coefficient quantization unit 206.

Coefficient quantization unit 206 may be configured to perform quantization of the transform coefficients. As described above, the degree of quantization may be modified by adjusting a quantization parameter. Coefficient quantization unit 206 may be further configured to determine quantization parameters and output QP data (e.g., data used to determine a quantization group size and/or delta QP values) that may be used by a video decoder to reconstruct a quantization parameter to perform inverse quantization during video decoding. It should be noted that in other examples, one or more additional or alternative parameters may be used to determine a level of quantization (e.g., scaling factors). The techniques described herein may be generally applicable to determining a level of quantization for transform coefficients corresponding to a component of video data based on a level of quantization for transform coefficients corresponding another component of video data.

As illustrated in FIG. 11, quantized transform coefficients are output to inverse quantization/transform processing unit 208. Inverse quantization/transform processing unit 208 may be configured to apply an inverse quantization and an inverse transformation to generate reconstructed residual data. As illustrated in FIG. 11, at summer 210, reconstructed residual data may be added to a predictive video block. In this manner, an encoded video block may be reconstructed and the resulting reconstructed video block may be used to evaluate the encoding quality for a given prediction, transformation, and/or quantization. Video encoder 200 may be configured to perform multiple coding passes (e.g., perform encoding while varying one or more of a prediction, transformation parameters, and quantization parameters). The rate-distortion of a bitstream or other system parameters may be optimized based on evaluation of reconstructed video blocks. Further, reconstructed video blocks may be stored and used as reference for predicting subsequent blocks.

As described above, a video block may be coded using an intra prediction. Intra prediction processing unit 212 may be configured to select an intra prediction mode for a video block to be coded. Intra prediction processing unit 212 may be configured to evaluate a frame and/or an area thereof and determine an intra prediction mode to use to encode a current block. As illustrated in FIG. 11, intra prediction processing unit 212 outputs intra prediction data (e.g., syntax elements) to entropy encoding unit 218 and transform coefficient generator 204. As described above, a transform performed on residual data may be mode dependent. As described above, possible intra prediction modes may include planar prediction modes, DC prediction modes, and angular prediction modes. Further, in some examples, a prediction for a chroma component may be inferred from an intra prediction for a luma prediction mode. Inter prediction processing unit 214 may be configured to perform inter prediction coding for a current video block. Inter prediction processing unit 214 may be configured to receive source video blocks and calculate a motion vector for PUs of a video block. A motion vector may indicate the displacement of a PU (or similar coding structure) of a video block within a current video frame relative to a predictive block within a reference frame. Inter prediction coding may use one or more reference pictures. Further, motion prediction may be uni-predictive (use one motion vector) or bi-predictive (use two motion vectors). Inter prediction processing unit 214 may be configured to select a predictive block by calculating a pixel difference determined by, for example, sum of absolute difference (SAD), sum of square difference (SSD), or other difference metrics. As described above, a motion vector may be determined and specified according to motion vector prediction. Inter prediction processing unit 214 may be configured to perform motion vector prediction, as described above. Inter prediction processing unit 214 may be configured to generate a predictive block using the motion prediction data. For example, inter prediction processing unit 214 may locate a predictive video block within a frame buffer (not shown in FIG. 11). It should be noted that inter prediction processing unit 214 may further be configured to apply one or more interpolation filters to a reconstructed residual block to calculate sub-integer pixel values for use in motion estimation. Inter prediction processing unit 214 may output motion prediction data for a calculated motion vector to entropy encoding unit 218. As illustrated in FIG. 11, inter prediction processing unit 214 may receive reconstructed video block via post filter unit 216. Post filter unit 216 may be configured to perform deblocking and/or Sample Adaptive Offset (SAO) filtering. Deblocking refers to the process of smoothing the boundaries of reconstructed video blocks (e.g., make boundaries less perceptible to a viewer). SAO filtering is a non-linear amplitude mapping that may be used to improve reconstruction by adding an offset to reconstructed video data.

Referring again to FIG. 11, entropy encoding unit 218 receives quantized transform coefficients and predictive syntax data (i.e., intra prediction data, motion prediction data, QP data, etc.). It should be noted that in some examples, coefficient quantization unit 206 may perform a scan of a matrix including quantized transform coefficients before the coefficients are output to entropy encoding unit 218. In other examples, entropy encoding unit 218 may perform a scan. Entropy encoding unit 218 may be configured to perform entropy encoding according to one or more of the techniques described herein. Entropy encoding unit 218 may be configured to output a compliant bitstream, i.e., a bitstream that a video decoder can receive and reproduce video data therefrom.

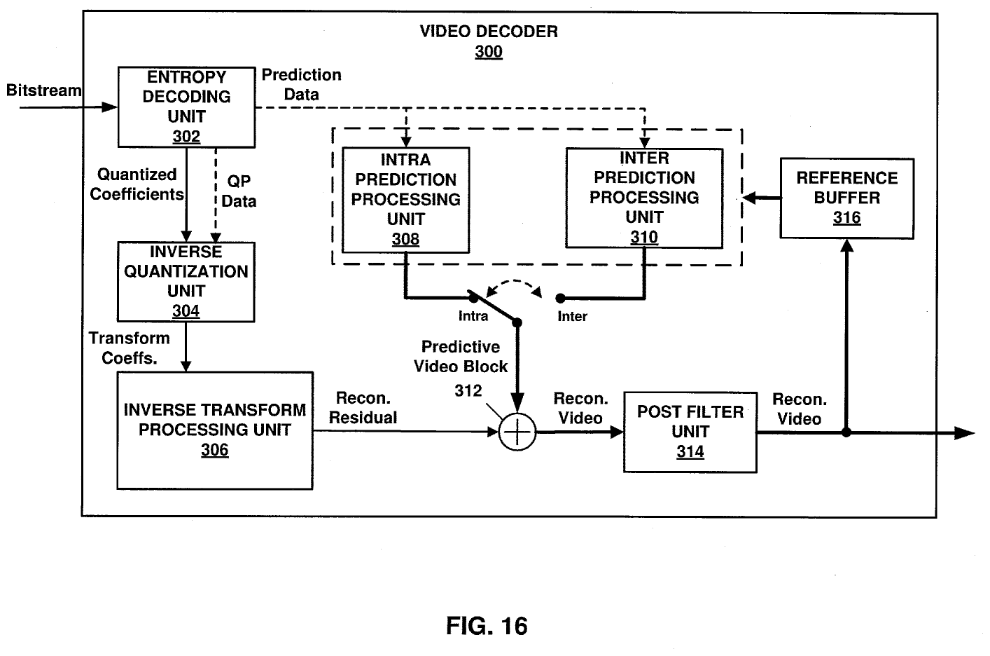

FIG. 16 is a block diagram illustrating an example of a video decoder that may be configured to decode video data according to one or more techniques of this disclosure. In one example, video decoder 300 may be configured to reconstruct video data based on one or more of the techniques described above. That is, video decoder 300 may operate in a reciprocal manner to video encoder 200 described above. Video decoder 300 may be configured to perform intra prediction decoding and inter prediction decoding and, as such, may be referred to as a hybrid decoder. In the example illustrated in FIG. 16 video decoder 300 includes an entropy decoding unit 302, inverse quantization unit 304, inverse transformation processing unit 306, intra prediction processing unit 308, inter prediction processing unit 310, summer 312, post filter unit 314, and reference buffer 316. Video decoder 300 may be configured to decode video data in a manner consistent with a video encoding system, which may implement one or more aspects of a video coding standard. It should be noted that although example video decoder 300 is illustrated as having distinct functional blocks, such an illustration is for descriptive purposes and does not limit video decoder 300 and/or subcomponents thereof to a particular hardware or software architecture. Functions of video decoder 300 may be realized using any combination of hardware, firmware, and/or software implementations.

As illustrated in FIG. 16, entropy decoding unit 302 receives an entropy encoded bitstream. Entropy decoding unit 302 may be configured to decode quantized syntax elements and quantized coefficients from the bitstream according to a process reciprocal to an entropy encoding process. Entropy decoding unit 302 may be configured to perform entropy decoding according any of the entropy coding techniques described above. Entropy decoding unit 302 may parse an encoded bitstream in a manner consistent with a video coding standard. Video decoder 300 may be configured to parse an encoded bitstream where the encoded bitstream is generated based on the techniques described above. That is, for example, video decoder 300 may be configured to determine partitioning structures generated and/or signaled based on one or more of the techniques described above for purposes of reconstructing video data. For example, video decoder 300 may be configured to parse syntax elements and/or evaluate properties of video data in order to determine a partitioning line.

Referring again to FIG. 16, inverse quantization unit 304 receives quantized transform coefficients (i.e., level values) and quantization parameter data from entropy decoding unit 302. Quantization parameter data may include any and all combinations of delta QP values and/or quantization group size values and the like described above. Video decoder 300 and/or inverse quantization unit 304 may be configured to determine QP values used for inverse quantization based on values signaled by a video encoder and/or through video properties and/or coding parameters. That is, inverse quantization unit 304 may operate in a reciprocal manner to coefficient quantization unit 206 described above. For example, inverse quantization unit 304 may be configured to infer predetermined values (e.g., determine a sum of QT depth and BT depth based on coding parameters), allowed quantization group sizes, and the like, according to the techniques described above. Inverse quantization unit 304 may be configured to apply an inverse quantization. Inverse transform processing unit 306 may be configured to perform an inverse transformation to generate reconstructed residual data. The techniques respectively performed by inverse quantization unit 304 and inverse transform processing unit 306 may be similar to techniques performed by inverse quantization/transform processing unit 208 described above. Inverse transform processing unit 306 may be configured to apply an inverse DCT, an inverse DST, an inverse integer transform, Non-Separable Secondary Transform (NSST), or a conceptually similar inverse transform processes to the transform coefficients in order to produce residual blocks in the pixel domain. Further, as described above, whether a particular transform (or type of particular transform) is performed may be dependent on an intra prediction mode. As illustrated in FIG. 16, reconstructed residual data may be provided to summer 312. Summer 312 may add reconstructed residual data to a predictive video block and generate reconstructed video data. A predictive video block may be determined according to a predictive video technique (i.e., intra prediction and inter frame prediction). In one example, video decoder 300 and the post filter unit 314 may be configured to determine QP values and use them for post filtering (e.g., deblocking). In one example, other functional blocks of the video decoder 300 which make use of QP may determine QP based on received signaling and use that for decoding.

Intra prediction processing unit 308 may be configured to receive intra prediction syntax elements and retrieve a predictive video block from reference buffer 316. Reference buffer 316 may include a memory device configured to store one or more frames of video data. Intra prediction syntax elements may identify an intra prediction mode, such as the intra prediction modes described above. In one example, intra prediction processing unit 308 may reconstruct a video block using according to one or more of the intra prediction coding techniques described herein. Inter prediction processing unit 310 may receive inter prediction syntax elements and generate motion vectors to identify a prediction block in one or more reference frames stored in reference buffer 316. Inter prediction processing unit 310 may produce motion compensated blocks, possibly performing interpolation based on interpolation filters. Identifiers for interpolation filters to be used for motion estimation with sub-pixel precision may be included in the syntax elements. Inter prediction processing unit 310 may use interpolation filters to calculate interpolated values for sub-integer pixels of a reference block. Post filter unit 314 may be configured to perform filtering on reconstructed video data. For example, post filter unit 314 may be configured to perform deblocking and/or SAO filtering, as described above with respect to post filter unit 216. Further, it should be noted that in some examples, post filter unit 314 may be configured to perform proprietary discretionary filter (e.g., visual enhancements). As illustrated in FIG. 16, a reconstructed video block may be output by video decoder 300. In this manner, video decoder 300 may be configured to generate reconstructed video data according to one or more of the techniques described herein. In this manner video decoder 300 may be configured to parse a first quad tree binary tree partitioning structure, apply the first quad tree binary tree partitioning structure to a first component of video data, determine a shared depth, and applying the first quad tree binary tree partitioning structure to a second component of video data up to the shared depth. In this manner, video decoder 300 represents an example of a device configured to determine an offset value and partition the leaf node according to the offset value.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computerreadable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computerreadable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Moreover, each functional block or various features of the base station device and the terminal device used in each of the aforementioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

Various examples have been described. These and other examples are within the scope of the following claims.

1. A method of partitioning video data for video coding, the method comprising:
receiving a video block including sample values for a component of video data;
partitioning the video block according to a partitioning line defined according to an angle and an distance; and
signaling the partitioning line based on allowed values for the angle and the distance, wherein the allowed values are based on one or more of properties of video data or video coding parameters.

2. The method of claim 1, wherein the allowed values for the angle and the distance are based on a height and width of the video block.

3. The method of claim 1, wherein the allowed values for the angle and the distance are based on a partitioning of a neighboring video block.

4. The method claim 1, wherein partitioning includes partitioning the video block into predictive blocks.

5. The method of claim 1, wherein the video block includes a coding block.

6. The method of claim 5, wherein the coding block is a leaf node of a quadtree binary tree.

7. A method of reconstructing video data, the method comprising:
determining residual data for a video block;
determining allowed values for an angle and distance, wherein the allowed values are based on one or more of properties of video data or video coding parameters;
parsing one or more syntax elements indicating values for the angle and the distance;
determining a partitioning line based on the indicated values for the angle and the distance;
for each partition resulting from the determined partitioning line,
generating predictive video data; and
reconstructing video data for the video block based on the residual data and the predictive video data.

8. The method of claim 7, wherein the allowed values for the angle and the distance are based on a height and width of the video block.

9. The method of claim 7, wherein the allowed values for the angle and the distance are based on a partitioning of a neighboring video block.

10. The method of claim 7, wherein the video block includes a coding block.

11. The method of claim 10, wherein the coding block is a leaf node of a quadtree binary tree.

12. A device for coding video data, the device comprising one or more processors configured to perform any and all combinations of the steps of claim 1.

13. The device of claim 12, wherein the device includes a video encoder.

14. The device of claim 12, wherein the device includes a video decoder.

15. A system comprising:
the device of claim 12 including a video encoder and a video decoder.

16. An apparatus for coding video data, the apparatus comprising means for performing any and all combinations of the steps of claim 1.

17. A non-transitory computer-readable storage medium comprising instructions stored thereon that, when executed, cause one or more processors of a device for coding video data to perform any and all combinations of the steps of claim 1.
